(19) United States
(12) Patent Application Publication
(10) Pub. No.: US 2014/0152848 A1
(43) Pub. Date: Jun. 5, 2014

(54) TECHNIQUE FOR CONFIGURING A DIGITAL CAMERA

(71) Applicant: NVIDIA CORPORATION, Santa Clara, CA (US)

(72) Inventor: Michael Brian COX, Menlo Park, CA (US)

(73) Assignee: NVIDIA CORPORATION, Santa Clara, CA (US)

(21) Appl. No.: 13/693,794

(22) Filed: Dec. 4, 2012

(51) Int. Cl. H04N 5/225

(52) U.S. Cl. CPC H04N 5/225
USPC 348/207.1

(57) ABSTRACT

A camera tuning engine within a digital camera includes a machine learning engine that generates a configuration file for the digital camera based on raw images captured by the digital camera. The digital camera implements a set of rendering algorithms that render trial images from the raw images based on parameters included in the configuration file. A training engine within the camera tuning engine then compares the trial images to target images provided from an external source. Based on differences between the trial images and the target images, the training engine adjusts weight values within the machine learning engine. By performing this process iteratively, the training engine trains the machine learning engine to generate a configuration file that may be used by the digital camera to render images that are similar to the target images.

### BACKGROUND OF THE INVENTION

1. Field of the Invention

The present invention generally relates to digital photography, and, more specifically, to a technique for configuring a digital camera.

2. Description of the Related Art

A conventional digital camera is manufactured with a set of optical components that includes one or more lenses and a light sensor of some kind, such as a color filter array (CFA) or charge-coupled device (CCD). When the digital camera captures raw digital images, an image signal processor (ISP) within the camera processes those raw images according to a set of rendering algorithms to produce a rendered image.

The precise functionality of those rendering algorithms typically varies across manufacturers. For example, digital cameras within Apple® products as the iPhone® and iPod® employ rendering algorithms that produce rendered images having a high color saturation. The functionality of the rendering algorithms may also vary across geographic regions due to expected differences in the lighting of a given region. For example, many of the streetlights in South Korea are green, and so digital cameras sold in that part of the world may filter or otherwise reduce green hues in pictures taken at night.

When manufacturing a digital camera, a team of engineers iteratively tunes various parameters of the digital camera until “quality” images can be produced. The tuning process normally occurs by placing the camera into a controlled lighting environment, such as a light box, and iteratively capturing different images. The various parameters tuned by the engineering team typically correspond to constants associated with the rendering algorithms that affect the functionality of those rendering algorithms. By comparing images captured across different configurations of parameters, the engineering team is able to decide which configuration produces “quality” images.

The process outlined above is problematic, though, because the notion of “quality” is highly subjective and based on the manufacturer's preferences as well as user preferences corresponding to the intended region of sale. Accordingly, tuning the configuration of a given digital camera can require an enormous amount of time until the images created by that camera are “just right.” Compounding this issue is the fact that different digital camera models could implement different optical components, and so the engineering team must perform the tuning process at least once for each such camera model. Additionally, the optical components implemented within digital cameras of the same model may vary due to, e.g., manufacturing differences in the optical components, such as lens flaws, among others. These variations must also be accounted for through tuning.

In sum, the camera tuning process requires an enormous amount of time and resources. Accordingly, what is needed in the art is a more effective technique for tuning a digital camera.

### SUMMARY OF THE INVENTION

One embodiment of the present invention includes a computer-implemented method for configuring a digital camera, including receiving a first set of images, causing a machine learning engine to generate a configuration file based on the first set of images as well as a set of weight values included within the machine learning engine, configuring a processing unit within the digital camera based on the configuration file, wherein the processing unit implements a set of rendering algorithms that performs rendering operations based on configuration parameters included within the configuration file, and rendering, via the processing unit, a second set of images based on the first set of images.

Advantageously, a digital camera may be effectively tuned to account for manufacturer preferences, regional preferences, and hardware inconsistencies by simply providing a set of target images to the digital camera for training purposes. Such an approach reduces the time and resources required to produce the digital camera.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a computer system configured to implement one or more aspects of the present invention;

FIG. 2 is a block diagram of a parallel processing subsystem for the computer system of FIG. 1, according to one embodiment of the present invention;

FIG. 3 is a block diagram that illustrates a digital camera, according to one embodiment of the present invention; and

FIG. 4 is a flowchart of method steps for optimizing configuration parameters associated with the digital camera of FIG. 3, according to one embodiment of the present invention.

### DETAILED DESCRIPTION

In the following description, numerous specific details are set forth to provide a more thorough understanding of the present invention. However, it will be apparent to one of skill in the art that the present invention may be practiced without one or more of these specific details. In other instances, well-known features have not been described in order to avoid obscuring the present invention.

### System Overview

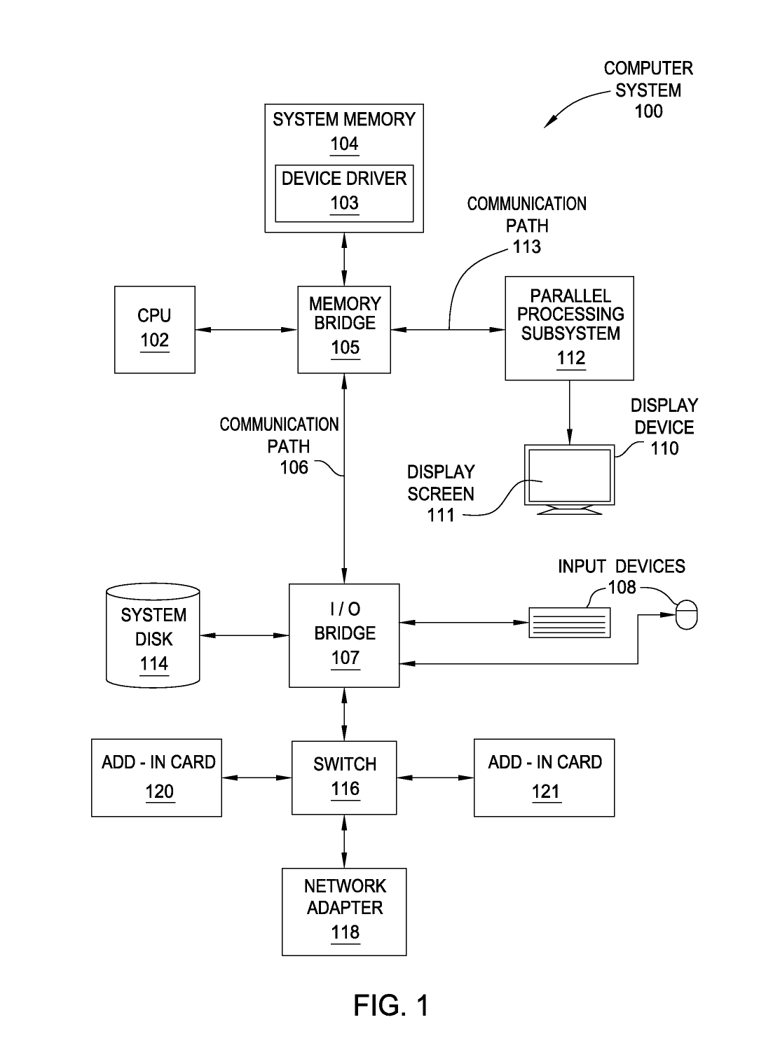

FIG. 1 is a block diagram illustrating a computer system 100 configured to implement one or more aspects of the present invention. Computer system 100 includes a central processing unit (CPU) 102 and a system memory 104 that includes a device driver 103. CPU 102 and system memory 104 communicate via an interconnection path that may include a memory bridge 105. Memory bridge 105, which may be, e.g., a Northbridge chip, is connected via a bus or other communication path 106 (e.g., a HyperTransport link) to an input/output (I/O) bridge 107. I/O bridge 107, which may be, e.g., a Southbridge chip, receives user input from one or more user input devices 108 (e.g., keyboard, mouse) and forwards the input to CPU 102 via path 106 and memory bridge 105. A parallel processing subsystem 112 is coupled to memory bridge 105 via a bus or other communication path 113 (e.g., a peripheral component interconnect (PCI) express, Accelerated Graphics Port (AGP), or HyperTransport link); in one embodiment parallel processing subsystem 112 is a graphics subsystem that delivers pixels to a display device 110 (e.g., a conventional cathode ray tube (CRT) or liquid crystal display (LCD) based monitor). A system disk 114 is also connected to I/O bridge 107. A switch 116 provides connections between I/O bridge 107 and other components such as a network adapter 118 and various add-in cards 120 and 121. Other components (not explicitly shown), including universal serial bus (USB) or other port connections, compact disc (CD) drives, digital video disc (DVD) drives, film recording devices, and the like, may also be connected to I/O bridge 107. Communication paths interconnecting the various components in FIG. 1 may be implemented using any suitable protocols, such as PCI, PCI Express (PCIe), AGP, HyperTransport, or any other bus or point-to-point communication protocol(s), and connections between different devices may use different protocols as is known in the art.

In one embodiment, the parallel processing subsystem 112 incorporates circuitry optimized for graphics and video processing, including, for example, video output circuitry, and constitutes a graphics processing unit (GPU). In another embodiment, the parallel processing subsystem 112 incorporates circuitry optimized for general purpose processing, while preserving the underlying computational architecture, described in greater detail herein. In yet another embodiment, the parallel processing subsystem 112 may be integrated with one or more other system elements, such as the memory bridge 105, CPU 102, and I/O bridge 107 to form a system on chip (SoC).

It will be appreciated that the system shown herein is illustrative and that variations and modifications are possible. The connection topology, including the number and arrangement of bridges, the number of CPUs 102, and the number of parallel processing subsystems 112, may be modified as desired. For instance, in some embodiments, system memory 104 is connected to CPU 102 directly rather than through a bridge, and other devices communicate with system memory 104 via memory bridge 105 and CPU 102. In other alternative topologies, parallel processing subsystem 112 is connected to I/O bridge 107 or directly to CPU 102, rather than to memory bridge 105. In still other embodiments, I/O bridge 107 and memory bridge 105 might be integrated into a single chip. Large embodiments may include two or more CPUs 102 and two or more parallel processing systems 112. The particular components shown herein are optional; for instance, any number of add-in cards or peripheral devices might be supported. In some embodiments, switch 116 is eliminated, and network adapter 118 and add-in cards 120, 121 connect directly to I/O bridge 107.

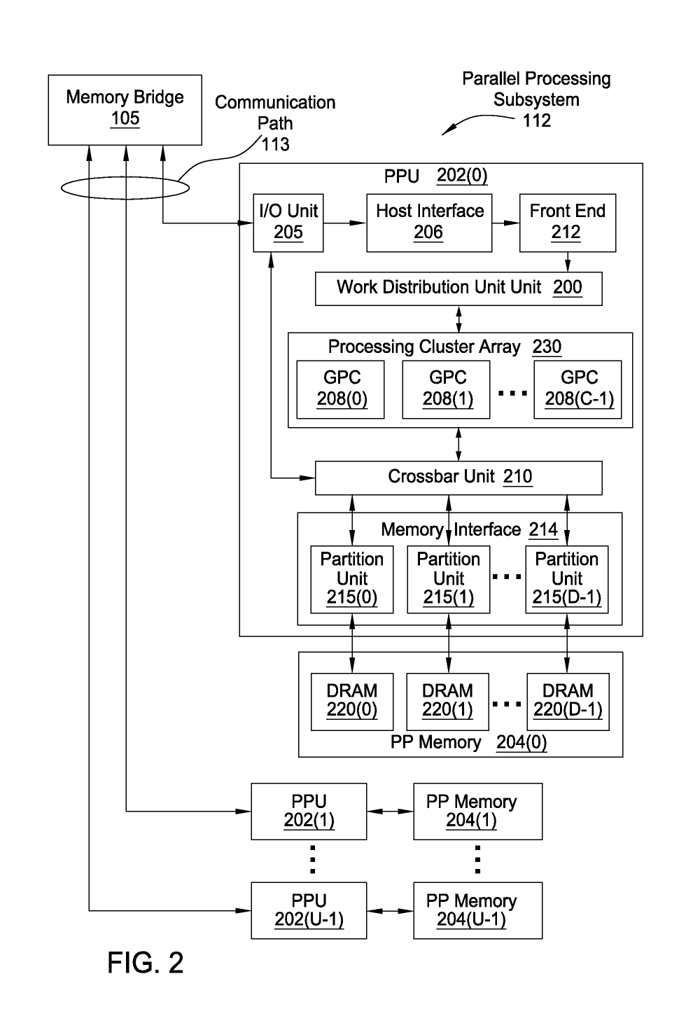

FIG. 2 illustrates a parallel processing subsystem 112, according to one embodiment of the present invention. As shown, parallel processing subsystem 112 includes one or more parallel processing units (PPUs) 202, each of which is coupled to a local parallel processing (PP) memory 204. In general, a parallel processing subsystem includes a number U of PPUs, where U≧1. (Herein, multiple instances of like objects are denoted with reference numbers identifying the object and parenthetical numbers identifying the instance where needed.) PPUs 202 and parallel processing memories 204 may be implemented using one or more integrated circuit devices, such as programmable processors, application specific integrated circuits (ASICs), or memory devices, or in any other technically feasible fashion.

Referring again to FIG. 1, in some embodiments, some or all of PPUs 202 in parallel processing subsystem 112 are graphics processors with rendering pipelines that can be configured to perform various tasks related to generating pixel data from graphics data supplied by CPU 102 and/or system memory 104 via memory bridge 105 and bus 113, interacting with local parallel processing memory 204 (which can be used as graphics memory including, e.g., a conventional frame buffer) to store and update pixel data, delivering pixel data to display device 110, and the like. In some embodiments, parallel processing subsystem 112 may include one or more PPUs 202 that operate as graphics processors and one or more other PPUs 202 that are used for general-purpose computations. The PPUs may be identical or different, and each PPU may have its own dedicated parallel processing memory device(s) or no dedicated parallel processing memory device(s). One or more PPUs 202 may output data to display device 110 or each PPU 202 may output data to one or more display devices 110.

In operation, CPU 102 is the master processor of computer system 100, controlling and coordinating operations of other system components. In particular, CPU 102 issues commands that control the operation of PPUs 202. In some embodiments, CPU 102 writes a stream of commands for each PPU 202 to a pushbuffer (not explicitly shown in either FIG. 1 or FIG. 2) that may be located in system memory 104, parallel processing memory 204, or another storage location accessible to both CPU 102 and PPU 202. PPU 202 reads the command stream from the pushbuffer and then executes commands asynchronously relative to the operation of CPU 102.

Referring back now to FIG. 2, each PPU 202 includes an I/O unit 205 that communicates with the rest of computer system 100 via communication path 113, which connects to memory bridge 105 (or, in one alternative embodiment, directly to CPU 102). The connection of PPU 202 to the rest of computer system 100 may also be varied. In some embodiments, parallel processing subsystem 112 is implemented as an add-in card that can be inserted into an expansion slot of computer system 100. In other embodiments, a PPU 202 can be integrated on a single chip with a bus bridge, such as memory bridge 105 or I/O bridge 107. In still other embodiments, some or all elements of PPU 202 may be integrated on a single chip with CPU 102.

In one embodiment, communication path 113 is a PCIe link, in which dedicated lanes are allocated to each PPU 202, as is known in the art. Other communication paths may also be used. An I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to parallel processing memory 204) may be directed to a memory crossbar unit 210. Host interface 206 reads each pushbuffer and outputs the work specified by the pushbuffer to a front end 212.

Each PPU 202 advantageously implements a highly parallel processing architecture. As shown in detail, PPU 202(0) includes a processing cluster array 230 that includes a number C of general processing clusters (GPCs) 208, where C≧1. Each GPC 208 is capable of executing a large number (e.g., hundreds or thousands) of threads concurrently, where each thread is an instance of a program. In various applications, different GPCs 208 may be allocated for processing different types of programs or for performing different types of computations. For example, in a graphics application, a first set of GPCs 208 may be allocated to perform tessellation operations and to produce primitive topologies for patches, and a second set of GPCs 208 may be allocated to perform tessellation shading to evaluate patch parameters for the primitive topologies and to determine vertex positions and other per-vertex attributes. The allocation of GPCs 208 may vary dependent on the workload arising for each type of program or computation.

GPCs 208 receive processing tasks to be executed via a work distribution unit 200, which receives commands defining processing tasks from front end unit 212. Processing tasks include indices of data to be processed, e.g., surface (patch) data, primitive data, vertex data, and/or pixel data, as well as state parameters and commands defining how the data is to be processed (e.g., what program is to be executed). Work distribution unit 200 may be configured to fetch the indices corresponding to the tasks, or work distribution unit 200 may receive the indices from front end 212. Front end 212 ensures that GPCs 208 are configured to a valid state before the processing specified by the pushbuffers is initiated.

When PPU 202 is used for graphics processing, for example, the processing workload for each patch is divided into approximately equal sized tasks to enable distribution of the tessellation processing to multiple GPCs 208. A work distribution unit 200 may be configured to produce tasks at a frequency capable of providing tasks to multiple GPCs 208 for processing. By contrast, in conventional systems, processing is typically performed by a single processing engine, while the other processing engines remain idle, waiting for the single processing engine to complete its tasks before beginning their processing tasks. In some embodiments of the present invention, portions of GPCs 208 are configured to perform different types of processing. For example a first portion may be configured to perform vertex shading and topology generation, a second portion may be configured to perform tessellation and geometry shading, and a third portion may be configured to perform pixel shading in screen space to produce a rendered image. Intermediate data produced by GPCs 208 may be stored in buffers to allow the intermediate data to be transmitted between GPCs 208 for further processing.

Memory interface 214 includes a number D of partition units 215 that are each directly coupled to a portion of parallel processing memory 204, where D≧1. As shown, the number of partition units 215 generally equals the number of DRAM 220. In other embodiments, the number of partition units 215 may not equal the number of memory devices. Persons skilled in the art will appreciate that dynamic random access memories (DRAMs) 220 may be replaced with other suitable storage devices and can be of generally conventional design. A detailed description is therefore omitted. Render targets, such as frame buffers or texture maps may be stored across DRAMs 220, allowing partition units 215 to write portions of each render target in parallel to efficiently use the available bandwidth of parallel processing memory 204.

Any one of GPCs 208 may process data to be written to any of the DRAMs 220 within parallel processing memory 204. Crossbar unit 210 is configured to route the output of each GPC 208 to the input of any partition unit 215 or to another GPC 208 for further processing. GPCs 208 communicate with memory interface 214 through crossbar unit 210 to read from or write to various external memory devices. In one embodiment, crossbar unit 210 has a connection to memory interface 214 to communicate with I/O unit 205, as well as a connection to local parallel processing memory 204, thereby enabling the processing cores within the different GPCs 208 to communicate with system memory 104 or other memory that is not local to PPU 202. In the embodiment shown in FIG. 2, crossbar unit 210 is directly connected with I/O unit 205. Crossbar unit 210 may use virtual channels to separate traffic streams between the GPCs 208 and partition units 215.

Again, GPCs 208 can be programmed to execute processing tasks relating to a wide variety of applications, including but not limited to, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel shader programs), and so on. PPUs 202 may transfer data from system memory 104 and/or local parallel processing memories 204 into internal (on-chip) memory, process the data, and write result data back to system memory 104 and/or local parallel processing memories 204, where such data can be accessed by other system components, including CPU 102 or another parallel processing subsystem 112.

A PPU 202 may be provided with any amount of local parallel processing memory 204, including no local memory, and may use local memory and system memory in any combination. For instance, a PPU 202 can be a graphics processor in a unified memory architecture (UMA) embodiment. In such embodiments, little or no dedicated graphics (parallel processing) memory would be provided, and PPU 202 would use system memory exclusively or almost exclusively. In UMA embodiments, a PPU 202 may be integrated into a bridge chip or processor chip or provided as a discrete chip with a high-speed link (e.g., PCIe) connecting the PPU 202 to system memory via a bridge chip or other communication means.

As noted above, any number of PPUs 202 can be included in a parallel processing subsystem 112. For instance, multiple PPUs 202 can be provided on a single add-in card, or multiple add-in cards can be connected to communication path 113, or one or more of PPUs 202 can be integrated into a bridge chip. PPUs 202 in a multi-PPU system may be identical to or different from one another. For instance, different PPUs 202 might have different numbers of processing cores, different amounts of local parallel processing memory, and so on. Where multiple PPUs 202 are present, those PPUs may be operated in parallel to process data at a higher throughput than is possible with a single PPU 202. Systems incorporating one or more PPUs 202 may be implemented in a variety of configurations and form factors, including desktop, laptop, or handheld personal computers, servers, workstations, game consoles, embedded systems, and the like.

### Configuring a Digital Camera

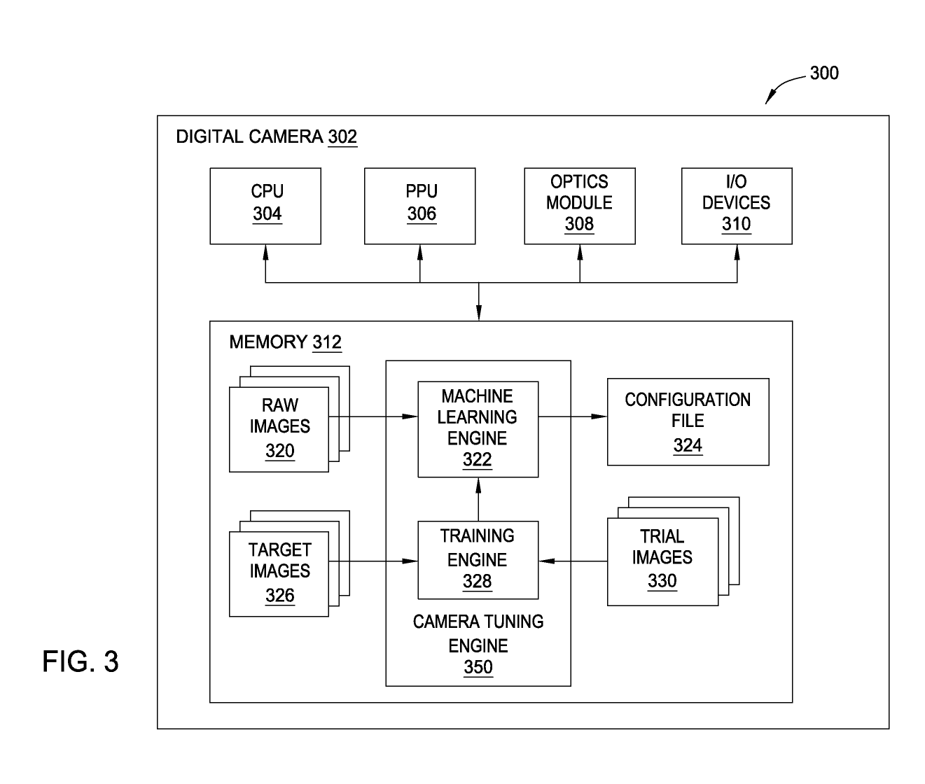

FIG. 3 is a block diagram 300 that illustrates a digital camera 302, according to one embodiment of the present invention. Digital camera 302 may be included within mobile devices, such as cell phones or tablet computers, or may represent a device dedicated to digital photography. By operating digital camera 302, a user may capture digital images. As shown, digital camera 302 includes a CPU 304, a PPU 306, an optics module 308, input/output (I/O) devices 310, and a memory 312. CPU 304 may be substantially similar to CPU 102 shown in FIG. 1, while PPU 306 may be substantially similar to PPU 202 shown in FIG. 2. In one embodiment, an image signal processor (ISP) may replace CPU 304 and/or PPU 306.

Optics module 308 is configured to receive light waves and to output an electrical signal that represents the color and intensity of those light waves, among other things. Optics module 308 could include, for example, a color filter array (CFA) or a charge-coupled device (CCD), as well as one or more lenses and/or apertures, among other things. I/O devices 310 may include input devices, such as a keypad, touchpad, a microphone, a shutter-release button, and so forth, as well as output devices, such as a screen, a speaker, one or more light-emitting diodes (LEDs), and so forth. In addition, I/O devices 310 may include devices capable of performing both input and output operations, such as a touch screen, an Ethernet port, a universal serial bus (USB) port, a serial port, etc. CPU 304, PPU 306, optics module 308, and I/O devices 310 are coupled together and coupled to memory 312.

Memory 312 could be any type of unit capable of storing data, including random-access memory (RAM), read-only memory (ROM), one or more hardware/software registers, a buffer, and so forth. As shown, memory 312 includes raw images 320, a camera tuning engine 350, a configuration file 324, target images 326, and trial images 330. Camera tuning engine 350 includes a machine learning engine 322 and a training engine 328.

Raw images 320 represent images captured by optics module 308. Raw images 320 may be captured by digital camera 302 when digital camera 302 is placed into a light box or other controlled lighting environment. Raw images 320 have not been subject to any post-processing by digital camera 302. Digital camera 302 renders trial images 330 by processing raw images 320 using one or more rendering algorithms. Those rendering algorithms perform rendering operations based on parameters included in configuration file 324. As such, the parameters within configuration file 324 may influence various qualities associated with trial images 330, such as lens shading, fringe effects, and other image qualities affected by rendering.

Target images 326 are provided into digital camera 302 when digital camera 302 undergoes a tuning process. The tuning process could occur on the assembly line during manufacturing of the digital camera when digital camera 302 is placed into the light box, as mentioned above. Target images 326 may be provided by the manufacturer of digital camera 302 and represent “ideal” images that, ideally, would be generated by digital camera 302 by rendering trial images 330 from raw images 320. Accordingly, one target image 326 may be provided for each one of trial images 330.

During the tuning process, camera tuning engine 350 is configured to generate a configuration file 324 that, when used to configure digital camera 302, causes digital camera 302 to render trial images 330 that are similar to target images 326. In doing so, camera tuning engine 350 generates and/or iteratively updates configuration file 324 based on raw images 320, target images 326, and trial images 330.

Machine learning engine 322 within camera tuning engine 250 is configured to implement one or more machine learning algorithms in order to generate/update configuration file 324 based on raw images 320. More specifically, machine learning engine 322 is configured to receive each pixel value of one or more raw images 320 as input, and produce each parameter value within configuration file 324 as output. Machine learning engine 322 includes a set of weight values and is configured to transform a given set of raw images 320 and corresponding pixel values into a set of parameter values comprising configuration file 324 using those weight values, in the fashion consistent with machine learning techniques. In one embodiment, machine learning engine 322 comprises an artificial neural network (ANN).

Camera tuning engine 350 also implements training engine 328 to adjust the weight values within machine learning engine 322 in the fashion consistent with machine learning techniques. In doing so, training engine 328 may cause machine learning engine 322 to generate a “better” configuration file 324 that, when used to configure digital camera 302, causes digital camera 302 to render trial images 330 that are more similar to target images 326 compared to previously generated trial images.

For example, training engine 328 could compare each trial image 330 to a corresponding target image 326 and compute differences in pixel values between those two images. Based on those differences, training engine 322 could adjust the weight values within machine learning engine 322 (e.g. using a cost function or gradient descent algorithm, etc.) to minimize the difference in pixel values between the two images. Training engine 322 could repeat this training process for each trial image/target image pair. Machine learning engine 322 could then generate an updated configuration file 324 using the adjusted weight values. Digital camera 302 could then generate a new set of trial images 330 based on the updated configuration file 324. Training engine 328 could then repeat the training process with the new set of trial images 330 generated using the updated configuration file 324. Training may continue in this fashion until the difference between each trial image 330 and the corresponding target image 326 falls below a given threshold (i.e. trial images 330 include pixel values within a threshold difference of pixel values associated with corresponding target images 326). In one embodiment, training engine 328 implements a backpropagation algorithm to adjust the weight values within machine learning engine 322.

In one embodiment, digital camera 302 captures raw images 320 within a light box and receives target images 326 from an external source, and then implements training engine 328 to perform an iteration of the training process described above. In doing so, training engine 328 compares each trial image 330 to each corresponding target image 326 and adjusts the weight values within machine learning engine 322 according to the difference between the images in each pair. Digital camera 302 may then capture a new set of raw images 320 and implement training engine 328 to perform additional iterations of the training process until machine learning engine 322 generates a suitable configuration file 324 (i.e. a configuration file 324 that may be used to generate trial images 330 that include pixel values within a threshold difference of pixel values associated with corresponding target images 326).

In another embodiment, digital camera 302 captures raw images 320 within a light box and receives target images 326 from an external source, and then implements training engine 328 to iteratively train machine learning engine 322 until machine learning engine 322 generates a suitable configuration file 324. In this embodiment, digital camera 302 need only capture one set of raw images 320.

In yet another embodiment, digital camera 302 may receive raw images 320 as well as target images 326 from an external source, and then implements training engine 328 to iteratively train machine learning engine 322 until machine learning engine 322 generates a suitable configuration file 324. In this embodiment, raw images 320 captured by a different camera may be provided to training engine 328 for training purposes, and digital camera 302 need not be placed into a light box.

By implementing the techniques described above, camera tuning engine 350 may generate a configuration file 324 that may be used by rendering algorithms within digital camera 302 to generate images consistent with the preferences of the manufacturer of digital camera 302 and/or the preferences of the potential buyer of digital camera 302.

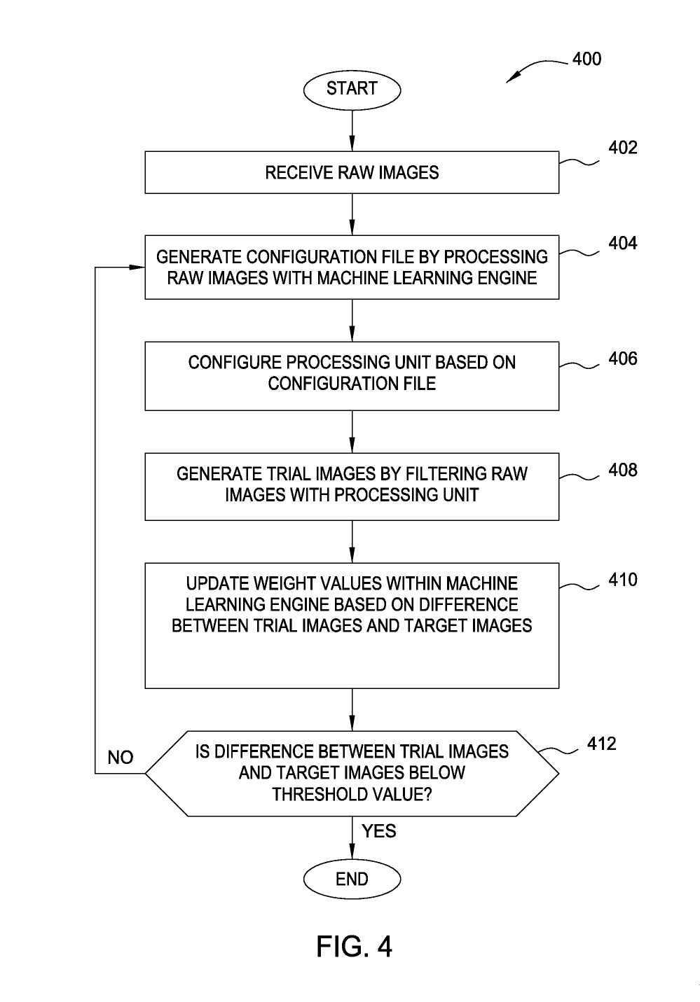

FIG. 4 is a flowchart of method steps for optimizing configuration parameters associated with the digital camera of FIG. 3, according to one embodiment of the present invention. Although the method steps are described in conjunction with the systems of FIGS. 1-3, persons skilled in the art will understand that any system configured to perform the method steps, in any order, is within the scope of the present invention.

As shown, a method 400 begins at step 402, where digital camera 302 receives raw images 320. The raw images 320 may be captured by optics module 308 within digital camera 302 or may be provided into digital camera 302 by an external source. At step 404, camera tuning engine 350 generates configuration file 324 by processing raw images 320 with machine learning engine 322. Machine learning engine 322 includes a set of weight values and may transform raw images 320 and corresponding pixel values into a set of parameter values comprising configuration file 324 using those weight values, in the fashion consistent with machine learning techniques.

At step 406, digital camera 302 configures a processing unit based on configuration file 324. The processing unit could be, e.g., an ISP, CPU 304, and/or PPU 306. In general, the processing unit implements a set of rendering algorithms when processing raw images 320 and those rendering algorithms perform rendering operations based on parameters included in configuration file 324. At step 408, digital camera 302 renders trial images 330 by processing raw images 320 with the configured processing unit. At step 410, training engine 328 updates the weight values within machine learning engine 322 based on the difference between the trial images 330 generated at step 410 and target images 326. Target images 326 represent “ideal” images that would, ideally be produced by digital camera 302 by processing raw images 320. In practice, target images 326 are provided by an external source.

When updating the weight values within machine learning engine 322 at step 410, training engine 328 could, for example, compare each trial image 330 to a corresponding target image 326 and compute differences in pixel values between those two images. Based on these differences, training engine 328 could modify the weight values within machine learning engine 322 to minimize the difference in pixel values between the two images.

At step 412, training engine 328 determines whether the difference between trial images 330 and target images 326 falls below a certain threshold. In doing so, training engine 328 may compare each pixel value of a given trial image 330 with a corresponding pixel value of a corresponding target image 326 and accumulate differences in pixel values across all pixels and all trial image 330/target image 326 pairs. If training engine 328 determines at step 412 that the difference between trial images 330 and target images 326 does not fall below the threshold, then the method 400 returns to step 404 and training engine 328 initiates another training iteration. In one embodiment, the method 400 returns to step 402 and digital camera 302 captures a new set of raw images 320.

If training engine 328 determines at step 412 that the difference between trial images 330 and target images 326 does fall below the threshold, then the method 400 ends. By implementing the method 400, one or more times, digital camera 302 may generate a configuration file 324 that may be used by digital camera 302 to render trial images 330 of comparable quality to target images 326.

In sum, a camera tuning engine within a digital camera includes a machine learning engine that generates a configuration file for the digital camera based on raw images captured by the digital camera. The digital camera implements a set of rendering algorithms that render trial images from the raw images based on parameters included in the configuration file. A training engine within the camera tuning engine then compares the trial images to target images provided from an external source. Based on differences between the trial images and the target images, the training engine adjusts weight values within the machine learning engine. By performing this process iteratively, the training engine trains the machine learning engine to generate a configuration file that may be used by the digital camera to render images that are similar to the target images.

Advantageously, a digital camera may be effectively tuned to account for manufacturer preferences, regional preferences, and hardware inconsistencies by simply providing a set of target images to the digital camera for training purposes. Such an approach reduces the time and resources required to produce the digital camera.

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

The invention has been described above with reference to specific embodiments. Persons skilled in the art, however, will understand that various modifications and changes may be made thereto without departing from the broader spirit and scope of the invention as set forth in the appended claims. The foregoing description and drawings are, accordingly, to be regarded in an illustrative rather than a restrictive sense.

The invention claimed is:

1. A computer-implemented method for configuring a digital camera, the method comprising:
receiving a first set of images;
causing a machine learning engine to generate a configuration file based on the first set of images as well as a set of weight values included within the machine learning engine;
configuring a processing unit within the digital camera based on the configuration file, wherein the processing unit implements a set of rendering algorithms that performs rendering operations based on configuration parameters included within the configuration file; and
rendering, via the processing unit, a second set of images based on the first set of images.

2. The computer-implemented method of claim 1, further comprising:
identifying pixel differences between each image in a third set of images and a corresponding image in the second set of images; and
causing a training engine to generate adjusted weight values for the machine learning engine by adjusting the weight values within the machine learning engine based on the pixel differences.

3. The computer-implemented method of claim 2, further comprising:
causing the machine learning engine to generate an updated configuration file based on the adjusted weight values;
configuring the processing unit based on the updated configuration file; and
rendering a fourth set of images based on the first set of images.

4. The computer-implemented method of claim 3, further comprising:
identifying pixel differences between each image in the third set of images and a corresponding image in the fourth set of images; and
determining that the pixel differences fall beneath a threshold value.

5. The computer-implemented method of claim 1, wherein, within a controlled lighting environment, the digital camera is configured to capture the first set of images via an optical sensor included in the digital camera.

6. The computer-implemented method of claim 1, wherein, within a controlled lighting environment, another digital camera is configured to capture the first set of images via an optical sensor included in the other digital camera, and wherein the digital camera receives the first set of images from the other digital camera.

7. The computer-implemented method of claim 6, wherein the optical sensor within the digital camera is different than the optical sensor within the other digital camera.

8. The computer-implemented method of claim 1, wherein the machine learning engine is configured to implement an artificial neural network, and the training engine is configured to implement a cost function to adjust the set of weight values within the machine learning engine.

9. A non-transitory computer-readable medium storing program instructions that, when executed by a processing unit, cause the processing unit to configure a digital camera by performing the steps of:
receiving a first set of images;
causing a machine learning engine to generate a configuration file based on the first set of images as well as a set of weight values included within the machine learning engine;
configuring a processing unit within the digital camera based on the configuration file, wherein the processing unit implements a set of rendering algorithms that performs rendering operations based on configuration parameters included within the configuration file; and
rendering, via the processing unit, a second set of images based on the first set of images.

10. The non-transitory computer-readable medium of claim 9, further comprising:
identifying pixel differences between each image in a third set of images and a corresponding image in the second set of images; and
causing a training engine to generate adjusted weight values for the machine learning engine by adjusting the weight values within the machine learning engine based on the pixel differences.

11. The non-transitory computer-readable medium of claim 10, further comprising the steps of:
causing the machine learning engine to generate an updated configuration file based on the adjusted weight values;
configuring the processing unit based on the updated configuration file; and
rendering a fourth set of images based on the first set of images.

12. The non-transitory computer-readable medium of claim 11, further comprising the steps of:
identifying pixel differences between each image in the third set of images and a corresponding image in the fourth set of images; and
determining that the pixel differences fall beneath a threshold value.

13. The non-transitory computer-readable medium of claim 9, wherein, within a controlled lighting environment, the digital camera is configured to capture the first set of images via an optical sensor included in the digital camera.

14. The non-transitory computer-readable medium of claim 9, wherein, within a controlled lighting environment, another digital camera is configured to capture the first set of images via an optical sensor included in the other digital camera, and wherein the digital camera receives the first set of images from the other digital camera.

15. The non-transitory computer-readable medium of claim 14, wherein the optical sensor within the digital camera is different than the optical sensor within the other digital camera.

16. The non-transitory computer-readable medium of claim 9, wherein the machine learning engine is configured to implement an artificial neural network, and the training engine is configured to implement a cost function to adjust the set of weight values within the machine learning engine.

17. A computing device configured to configure a digital camera, including:
a processing unit configured to:
receive a first set of images;
cause a machine learning engine to generate a configuration file based on the first set of images as well as a set of weight values included within the machine learning engine;
configure a set of rendering algorithms implemented by the processing unit based on the configuration file, wherein the set of rendering algorithms performs rendering operations based on configuration parameters included within the configuration file; and
render a second set of images based on the first set of images.

18. The computing device of claim 17, further including:
a memory storing program instructions that, when executed by the processing unit, cause the processing unit to:
receive the first set of images,
cause the machine learning engine to generate the configuration file,
configure the set of rendering algorithms, and
render the second set of images.

19. The computing device of claim 17, wherein the processing unit is further configured to:
identify pixel differences between each image in a third set of images and a corresponding image in the second set of images,
cause a training engine to generate adjusted weight values for the machine learning engine by adjusting the weight values within the machine learning engine based on the pixel differences,
cause the machine learning engine to generate an updated configuration file based on the adjusted weight values,
configure the processing unit based on the updated configuration file,
render a fourth set of images based on the first set of images,
identify pixel differences between each image in the third set of images and a corresponding image in the fourth set of images, and
determine that the pixel differences fall beneath a threshold value.

20. The computing device of claim 17, wherein, within a controlled lighting environment, the digital camera is configured to capture the first set of images via an optical sensor included in the digital camera, or, within the controlled lighting environment, another digital camera is configured to capture the first set of images via an optical sensor included in the other digital camera, the digital camera receiving the first set of images from the other digital camera.
